(19) United States
(12) Patent Application Publication
(10) Pub. No.: US 2008/0191619 A1
(43) Pub. Date: Aug. 14, 2008

(54) Elongated Display Fibers and Displays Made Thereof

(75) Inventor: Leendert Van Der Tempel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,234

(22) PCT Filed: Feb. 21, 2005
(86) PCT No.: PCT/IB05/50631

§ 371 Date: Aug. 22, 2006

(30) Foreign Application Priority Data
Mar. 2, 2004 (EP) 04100819.4

(51) Int. Cl. H05B 33/02

(52) U.S. Cl. 313/505

(57) ABSTRACT

The present invention relates to an elongated display fiber (1) comprising a plurality of electro luminescent pixel elements (2) distributed along the length of said fiber (1). The fiber (1) further comprises an electrical conductor matrix (3) consisting of intersecting row (R₁-Rₙ) and column (C₁-Cₙ) conductors disposed along the length of said fiber (1). An electrical connection (4) exist between each said intersection of said row (R₁,Rₙ) and column (C₁-Cₙ) conductors and a respective one of said electro luminescent pixel elements (2). Each respective said electro luminescent pixel element (2) can be caused to emit light through selective application of electrical signals to a respective combination of one of said row (R₁-Rₙ) conductors and one of said column (C₁-Cₙ) conductors. The present invention further relates to a display apparatus (6) comprising at least one elongated display fiber (1) according to the present invention.

### BACKGROUND OF THE INVENTION

1. Field of the Invention

The present patent application relates to the field of elongated display fibers, and displays comprising a plurality of such elongated display fibers.

2. Description of the Related Art

Electronic displays are used to present to a user various forms of display information, such as text, graphics, and video, as pixelized images. The presentation of pixelized display information may be an essential function of an electronic device, such as usually is the case with personal computers. Pixelized display information can also be used to enhance the features of an electronic device, such as enabling interaction between a user and an electronic device.

A number of electronic display technologies are available, each having specific attributes that limit their application. Cathode Ray Tubes (CRTs), for instance, are widely used for computer monitors and televisions. CRTs have good color, contrast, and brightness, as well as being a mature, economical technology. CRTs are not particularly compact, being limited by the geometries imposed by its electron gun and pixel elements formed at substantially perpendicular relation to the electron gun. Moreover, the vacuum requirements of a CRT dictate a heavy glass construction. Thus, the size, weight, rigid fragile construction, high acceleration voltages and power consumption of CRTs limits their use in portable applications.

As an alternative to CRTs, plasma screen technology allows for a display flatter and wider than CRTs and rear projection televisions. However, plasma screen technology is difficult to manufacture, and thus expensive. Moreover, although flatter than CRTs, plasma screens have similar limitations as do CRTs for high drive voltages weight and rigidity. Consequently, plasma screen displays are used in certain notebook computers and relatively expensive portable devices.

Various other technologies allow for flat, lighter weight, and lower power consumption than CRTs, appropriate to more portable applications. Liquid Crystal Displays (LCD) and active matrix LCDs (AMLCD) are e.g. widely used in notebook computers and personal digital assistant (PDA) products. To provide a degree of flexibility and resistance to impact, plastic LCDs are known. Although LCDs are generally less expensive than other displays of comparable size they are however generally too expensive to incorporate into limited life, disposable electronic products.

Previously known patent publication U.S. Pat. No. 6,259,838 B1 relates to a display as for images and/or information which comprises a plurality of linearly addressed light-emitting fibers disposed in side-by-side arrangement to define a viewing surface. Each light-emitting fiber includes a plurality of light-emitting elements disposed along its length which is linearly addressed by signals provided by a drive circuit at one end thereof. Linear addressing signals are either optical signals or electrical signals, and may be frequency modulated, digitally encoded or analog encoded. A detector associated with each pixel detects the linear addressing signal and decodes it to activate and deactivate organic or inorganic light-emitting material elements. Thus, the light-emitting elements emit light to display a pixel or sub-pixel of the image and/or information. The light-emitting fiber may include a transparent fiber as substrate for propagating the optical signals there through and may include electrical conductors disposed along its length for propagating the electrical signals.

A drawback of the above described display according to U.S. Pat. No. 6,259,838 B1 is that the fiber must be equipped with a plurality of detectors, one associated with each pixel. These detectors are necessary for detecting the linear addressing signals, and also needed to be able to decode the detected signals and provide for activation or deactivation of the associated light emitting elements. Thus this adds to the complexity of the fiber, which renders it more complicated to produce and increases the costs associated therewith.

Accordingly, there is a need for a light weight, low voltage, inexpensive display element having few connections, which display element can be produced more economically and which is suitable for use in displays for portable electronic devices and a variety of applications.

### SUMMARY OF THE INVENTION

Taking the above into mind, it is an object of the present invention to provide an improved display fiber comprising a plurality of electro luminescent pixel elements distributed along the length of said fiber, by which a light weight, inexpensive display element, which can be produced economically, requires a low number of connections and drivers, and which is suitable for use in displays for portable electronic devices as well as wearable displays and a variety of applications can be achieved.

This object is achieved in accordance with the characterizing portion of claim 1.

Thanks to the provision of an electrical conductor matrix consisting of intersecting row and column conductors disposed along the length of said fiber; an electrical connection between each said intersection of said row and column conductors and a respective one of said electro luminescent pixel elements, each respective said electro luminescent pixel element can be caused to emit light through selective application of electrical signals to a respective combination of one of said row conductors and one of said column conductors.

Preferred embodiments are listed in the dependent claims.

Through a respective electrical connection to each of said row and column conductors being brought to at least one end of said fiber, attachment of driver means to the at least one fiber end is facilitated.

Through said electrical conductor matrix being of a transparent material, preferably indium tin oxide (ITO), any visually disturbing effects which might occur when using a non-transparent electrical conductor matrix is eliminated and the quality and clarity of the display fiber is improved.

Through said electrical conductor matrix being slanted around said fiber, preferably at a slanting angle close to 180° a display matrix comprising a large number of pixel elements in each row thereof can be achieved, reducing the number of electrical connections necessary to address all pixel elements of the fiber.

Through said fiber being a polymer fiber, a flexible fiber suitable for flexible displays, such as for wearable applications can be achieved.

A display apparatus comprising at least one elongated display fiber can be achieved through associating display driver means with the display fiber.

An increased size viewing surface of the display apparatus can be achieved through disposing a plurality of display fibers, each with associated display driver means, in a side by side arrangement.

In order to provide a structurally defined viewing surface the display apparatus can be provided with a substrate on which said plurality of fibers are disposed in side by side arrangement.

A viewing surface of the display apparatus providing for improved quality image reproduction can be achieved through disposing the fibers as an array of essentially parallel fibers making up the viewing surface.

In order to enable use of the display apparatus for providing a viewing surface on garments and various other textile like applications the fibers can be disposed in the warp or weft of a fabric.

In an alternative for enabling use of the display apparatus for providing a viewing surface on garments and various other textile like applications the fibers can be disposed as meandering fibers in a fabric.

### BRIEF DESCRIPTION OF THE DRAWINGS

In the drawings, wherein like reference characters denote similar elements throughout the several views:

FIG. 1 discloses a schematic view of a display fiber in accordance with the present invention;

FIG. 2 discloses a schematic view of a first embodiment of a display apparatus in accordance with the present invention;

FIG. 3 discloses a schematic view of a second embodiment of a display apparatus in accordance with the present invention.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

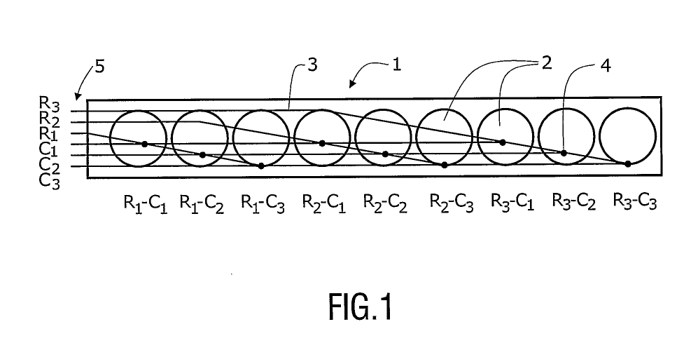

FIG. 1 shows a first embodiment of an elongated display fiber 1. The fiber 1 is preferably a weavable and wearable polymer fiber 1, of which it is possible to produce a textile like fabric. The fiber 1 comprises a plurality of electro luminescent pixel elements 2 distributed along the length thereof.

In accordance with the first embodiment of an elongated display fiber 1 in accordance with the present invention the fiber 1 further comprises an electrical conductor matrix 3 consisting of intersecting row R₁-Rₙ and column C₁-Cₙ conductors disposed along the length of the fiber 1 for conducting electrical signals along the fiber 1. An electrical connection 4 is provided between each intersection of row R₁-Rₙ and column C₁-Cₙ conductors and a respective one of the electro luminescent pixel elements 2. Each such electrical connection 4 can e.g. comprise a pair of first and second electrodes (not shown) one of which connects the associated row conductor R₁-Rₙ and the other one connecting the associated column conductor C₁-Cₙ with the associated electro luminescent pixel element 2. Each respective electro luminescent pixel element 2 can be caused to emit light through selective application of electrical signals to a respective combination of one of the row conductors R₁-Rₙ and one of the column conductors C₁-Cₙ. E.g. in FIG. 1, application of electrical signals to the combination of row conductor R₂ and column conductor C₁ will cause the fourth electro luminescent pixel element 2 (counting left to right) to emit light.

A respective electrical connection 5 to each of the row R₁-Rₙ and column C₁-Cₙ conductors of the electrical conductor matrix 3 is preferably brought to at least one end of the fiber 1 in order to facilitate the attachment of driver means (not shown) to the at least one fiber end in order to provide for sequential addressing of each of the pixel elements 2 through selective application of electrical signals to the respective combination of a row conductor Rₙ and a column conductor Cₙ connected to the pixel element 2 at the intersection 4 between this pair Rₙ, Cₙ of conductors.

The number of electrical connections 5 brought to the at least one end of the fiber 1 corresponds to two times the square root of the number of electro luminescent pixel elements 2 disposed along the length of the display fiber 1, e.g. as illustrated in FIG. 1, the number of pixel elements 2 are nine, the square root of which equals three, giving the number of connections 5 as six. This means that an elongated display fiber 1 in accordance with this first embodiment of the present invention having 256 pixel elements 2 would require 32 connections 5, and an elongated display fiber 1 in accordance with this first embodiment of the present invention having 625 pixel elements 2 would require 50 connections 5. Accordingly a factor limiting the maximum number of pixel elements 2 of an elongated display fiber 1 in accordance with this first embodiment of the present invention will be the dimension requirements of the conductors R₁-Rₙ, C₁-Cₙ of the electrical conductor matrix 3.

It is preferred that the electrical conductor matrix 3 consist of a transparent material and preferably the electrical conductor matrix 3 consist of indium tin oxide (ITO) conductors R₁-Rₙ, C₁-Cₙ and electrodes (not shown). Through the use of a transparent electrical conductor matrix 3 any visually disturbing effects which might occur when using a non-transparent electrical conductor matrix 3 is eliminated and the quality and clarity of the display fiber 1 is improved. The electrical conductor matrix 3 may be protected by at least one coating, e.g. a semi-transparent coating. Further, the electrical conductor matrix 3 is preferably wrapped around said fiber 1 slanted, with a slanting angle which for a fiber 1 comprising a large number of pixel elements 2 typically will be close to 180°, i.e. if the column conductors C₁-Cₙ extend essentially parallel to a center axis of the display fiber 1 the angle between them and the row conductors R₁-Rₙ will decrease towards 0° with the number of pixel elements 2 of each row, the limiting factor being the requirement of spacing between the conductors R₁-Rₙ, C₁-Cₙ and the requirement of each row conductor R₁-Rₙ intersecting all column conductors C₁-Cₙ.

For applications where said elongated display fiber 1 is used in a configuration where it is rotation fixed it can further comprise a back reflector (not shown) covering up to approximately 180° of a circumference of said fiber 1 in order to enhance the brightness in front of the fiber 1. As an alternative, a back reflector can be arranged behind said fiber 1 in corresponding manner in order to enhance the brightness in front of the fiber 1.

The present invention shall also encompass a display apparatus 6 comprising at least one elongated display fiber 1 in accordance with the present invention as well as an associated display driver means 7.

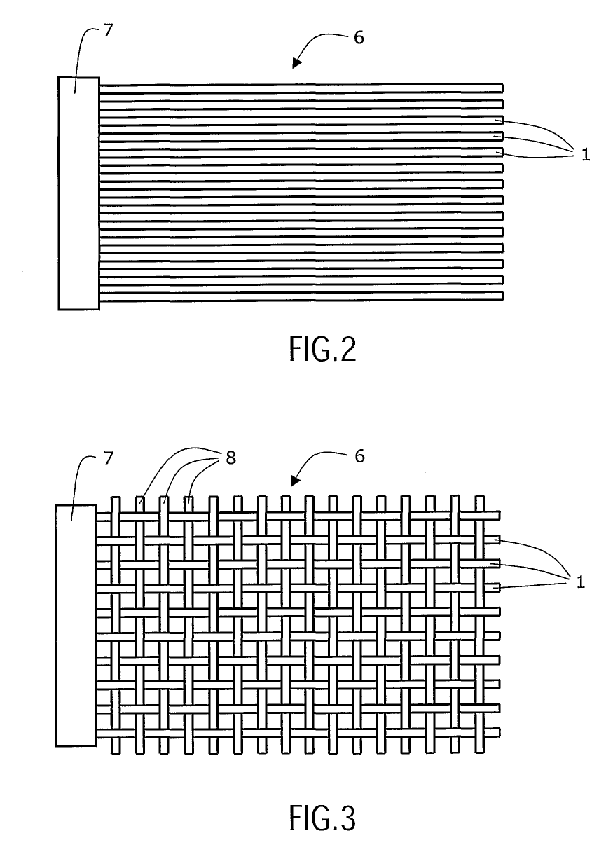

In a first embodiment, as illustrated schematically in FIG. 2, the display apparatus 6 comprises a plurality of elongated display fibers 1 disposed in a side by side arrangement to define a viewing surface thereof. If required for a specific application, the display fibers can be disposed on a backing substrate (not shown), which backing substrate may be a flexible substrate. The fibers 1 are preferably disposed as an array of essentially parallel fibers 1, for producing a uniform viewing surface. Each fiber 1 is associated with display driver means 7 connected to the row R₁-Rₙ and column C₁-Cₙ conductor connections 5 thereof.

In a second embodiment, as illustrated schematically in FIG. 3, the display apparatus 6 comprises a plurality of elongated display fibers 1 disposed in a fabric along with other fibers 8 thereof, preferably a textile fabric, defining a viewing surface thereof. The fibers 1 can be disposed in a warp or weft of the fabric or alternatively disposed as meandering fibers 1 in the fabric. As in the first embodiment, each fiber 1 is associated with display driver means 7 connected to the row R₁-Rₙ and column C₁-Cₙ conductor connections 5 thereof. The relatively low number of electrical connections 5 required using display fibers 1 in accordance with the present invention is very advantageous for producing wearable displays. The suitability for wearable displays can be further enhanced through making the electrical connections 5 flexible.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An elongated display fiber (1) comprising a plurality of electro luminescent pixel elements (2) distributed along the length of said fiber (1), characterized in that it further comprises: an electrical conductor matrix (3) consisting of intersecting row (R₁-Rₙ) and column (C₁-Cₙ) conductors disposed along the length of said fiber (1); an electrical connection (4) between each said intersection of said row (R₁-Rₙ) and column (C₁-Cₙ) conductors and a respective one of said electro luminescent pixel elements (2) whereby each respective said electro luminescent pixel element (2) can be caused to emit light through selective application of electrical signals to a respective combination of one of said row (R₁-Rₙ) conductors and one of said column (C₁-Cₙ) conductors.

2. The elongated display fiber (1) of claim 1, characterized in that it further comprises a respective electrical connection (5) to each of said row (R₁-Rₙ) and column (C₁-Cₙ) conductors brought to at least one end of said fiber (1).

3. The elongated display fiber (1) of claim 1, characterized in said electrical conductor matrix (3) being of a transparent material, preferably indium tin oxide (ITO).

4. The elongated display fiber (1) of claim 1, characterized in said electrical conductor matrix (3) being slanted around said fiber (1), preferably at a slanting angle close to 180°.

5. The elongated display fiber (1) of claim 2, characterized in said fiber (1) being a polymer fiber.

6. A display apparatus (6), characterized in that it further comprises at least one elongated display fiber (1) according to claim 1 and an associated display driver means (7).

7. The display apparatus (6) of claim 6, characterized in that it further comprises a plurality of said fibers (1) disposed in a side by side arrangement to define a viewing surface of said display apparatus (6).

8. The display apparatus (6) of claim 7, characterized in that it further comprises a substrate on which said plurality of fibers (1) are disposed in said side by side arrangement.

9. The display apparatus (6) of claim 6 characterized in that it further comprises a plurality of said fibers (1) disposed as an array of essentially parallel fibers (1).

10. The display apparatus (6) of claim 6 characterized in that it further comprises a plurality of said fibers (1) disposed in a warp or weft of a fabric.

11. The display apparatus (6) of claim 6 characterized in that it further comprises a plurality of said fibers (1) disposed as meandering fibers (1) in a fabric.

12. The display apparatus (6) of claim 10 characterized in said fabric being a textile.
